(19) United States
(12) Patent Application Publication
(10) Pub. No.: US 2024/0102800 A1
(43) Pub. Date: Mar. 28, 2024

(54) SURVEYING APPARATUS, AND METHOD AND PROGRAM FOR OPERATING SURVEYING APPARATUS

(71) Applicant: TOPCON CORPORATION, Tokyo (JP)

(72) Inventors: You SASAKI, Tokyo (JP); Hideki MORITA, Tokyo (JP); Hiroaki SUGIMOTO, Tokyo (JP); Yuto SUZUKI, Tokyo (JP); Shuichi MINAMIGUCHI, Tokyo (JP); Nobuyuki NISHITA, Tokyo (JP); Hideyuki MATSUMOTO, Tokyo (JP)

(73) Assignee: TOPCON CORPORATION, Tokyo (JP)

(21) Appl. No.: 18/470,744

(22) Filed: Sep. 20, 2023

(30) Foreign Application Priority Data
Sep. 26, 2022 (JP) 2022-152358

(51) Int. Cl. G01C 9/06; G01C 15/06

(52) U.S. Cl. CPC G01C 9/06; G01C 15/06; G01C 2009/066

(57) ABSTRACT

Efficiency of operation related to acquisition of a tilt offset of a surveying apparatus is improved. A total station includes a tilt sensor, a tilt offset acquisition unit that acquires a tilt offset of the tilt sensor, a measurement unit that measures a variable value of a phenomenon that can cause the tilt offset to vary, and a determination unit that determines whether to acquire the tilt offset, based on output from the measurement unit.

### CROSS-REFERENCE TO RELATED APPLICATIONS

This application claims the benefit of priority under 35 U.S.C. 119 to Japanese Patent Application No. 2022-152358, filed Sep. 26, 2022; the disclosure of which is incorporated herein by reference in their entirety.

### FIELD

The present invention relates to a technique for improving efficiency in surveying using a surveying apparatus.

### BACKGROUND

Most surveying apparatuses include a tilt sensor. It is necessary to know a tilt offset when using a tilt sensor. Techniques related to tilt of surveying apparatuses are disclosed in, for example, Japanese Patents Nos. 6490477 and 4996371.

### SUMMARY OF THE INVENTION

Normally, a tilt offset is obtained each time a surveying apparatus is set up at an instrument point. This operation takes time and requires labor.

In view of these circumstances, an object of the present invention is to improve efficiency of operation related to acquisition of a tilt offset of a surveying apparatus.

The present invention provides a surveying apparatus including a tilt sensor, a tilt offset acquisition unit being configured to acquire a tilt offset of the tilt sensor, a measurement unit being configured to measure a variable value of a phenomenon that can cause the tilt offset to vary, and a determination unit being configured to determine whether to acquire the tilt offset, based on output from the measurement unit.

In one aspect of the present invention, the phenomenon may include at least one of variations in temperature, variations in atmospheric pressure, variations in impact, and elapse of time. In one aspect of the present invention, the measurement unit may include at least one of a temperature sensor, an atmospheric pressure sensor, an acceleration sensor, and a clock.

The present invention also provides a surveying apparatus including a tilt sensor, a tilt offset acquisition unit being configured to acquire a tilt offset of the tilt sensor, a temperature sensor being configured to measure a temperature of the tilt sensor or a temperature of environment in which the tilt sensor is placed, and a determination unit being configured to determine whether to acquire the tilt offset, based on output from the temperature sensor.

The present invention also provides a surveying apparatus including a tilt sensor, a tilt offset acquisition unit being configured to acquire a tilt offset of the tilt sensor, an acceleration sensor being configured to measure an acceleration applied to the tilt sensor, and a determination unit being configured to determine whether to acquire the tilt offset, based on output from the acceleration sensor.

The present invention also provides a surveying apparatus including a tilt sensor, a tilt offset acquisition unit being configured to acquire a tilt offset of the tilt sensor, and a determination unit being configured to determine whether to acquire the tilt offset, based on elapse of time from acquisition of the tilt offset at a previous time.

The present invention also provides a method for operating a surveying apparatus that includes a tilt sensor, a tilt offset acquisition unit being configured to acquire a tilt offset of the tilt sensor, and a measurement unit being configured to measure a variable value of a phenomenon that can cause the tilt offset to vary. The method includes determining whether to acquire the tilt offset, based on output from the measurement unit.

The present invention also provides a non-transitory computer recording medium storing computer executable instructions for controlling operation of a surveying apparatus. The surveying apparatus includes a tilt sensor, a tilt offset acquisition unit being configured to acquire a tilt offset of the tilt sensor, and a measurement unit being configured to measure a variable value of a phenomenon that can cause the tilt offset to vary. The computer executable instructions are made to, when read and executed by a computer processor, cause the computer processor to determine whether to acquire the tilt offset, based on output from the measurement unit.

The present invention also provides a surveying apparatus including a horizontal rotation unit having a measurement device, a tilt sensor being disposed on the horizontal rotation unit, and a tilt offset acquisition unit being configured to acquire a tilt offset of the tilt sensor. The tilt offset is acquired when surrounding environment is measured by the measurement device while the horizontal rotation unit is rotated horizontally. In one aspect of the present invention, the surveying apparatus may further include a non-rotatable unit supporting the horizontal rotation unit, and another tilt sensor being disposed on the non-rotatable unit. In this case, variations in tilt of the surveying apparatus itself may be measured by the another tilt sensor while the horizontal rotation unit is rotated horizontally.

The present invention also provides a surveying apparatus being configured to perform surveying. The surveying apparatus includes a tilt sensor and a tilt offset acquisition unit being configured to acquire a tilt offset of the tilt sensor. The tilt offset is acquired in response to reception of instruction for executing certain surveying in the surveying. In one aspect of the present invention, the surveying apparatus may further include a horizontal rotation unit mounted with the tilt sensor, a non-rotatable unit supporting the horizontal rotation unit, and another tilt sensor being disposed on the non-rotatable unit. In this case, variations in tilt of the surveying apparatus itself may be measured by the another tilt sensor while the horizontal rotation unit is rotated horizontally.

The present invention enables improving efficiency of operation related to acquisition of a tilt offset of a surveying apparatus.

### BRIEF DESCRIPTION OF DRAWINGS

FIG. 1 shows an external appearance of a total station.

FIG. 2 is a conceptual diagram of an automatic leveling mechanism.

FIG. 3 is a block diagram of the total station.

FIG. 4 is a flowchart showing an example of a processing procedure.

FIG. 5 is a graph showing an example of a case of using an integrated value of temperature variations for determination.

### DETAILED DESCRIPTION

### 1. First Embodiment

### Surveying Apparatus

FIG. 1 shows a total station 100 as an example of a surveying apparatus. Examples of the surveying apparatus include a laser scanning apparatus and a theodolite, in addition to a total station.

The total station 100 is supported by a tripod 101. An automatic leveling mechanism 110 (tribrach) is placed on top of the tripod 101. A horizontally rotatable horizontal rotation unit 102 is disposed on top of the automatic leveling mechanism 110. The horizontal rotation unit 102 includes a vertically rotatable vertical rotation unit 103. The vertical rotation unit 103 includes an optical unit 104, which emits distance measuring light to the outside and receives the distance measuring light that is reflected back. The optical unit 104 is used also as an optical system of a telescope for sighting in surveying.

Although details are omitted, the vertical rotation unit 103 also includes an optical system that emits and detects laser light for capturing and tracking a target (e.g., a surveying target, such as a reflection prism). The total station 100 makes the horizontal rotation unit 102 rotate horizontally and makes the vertical rotation unit 103 rotate vertically, in order to capture and track a surveying target. This is a function that is given to commercially available total stations.

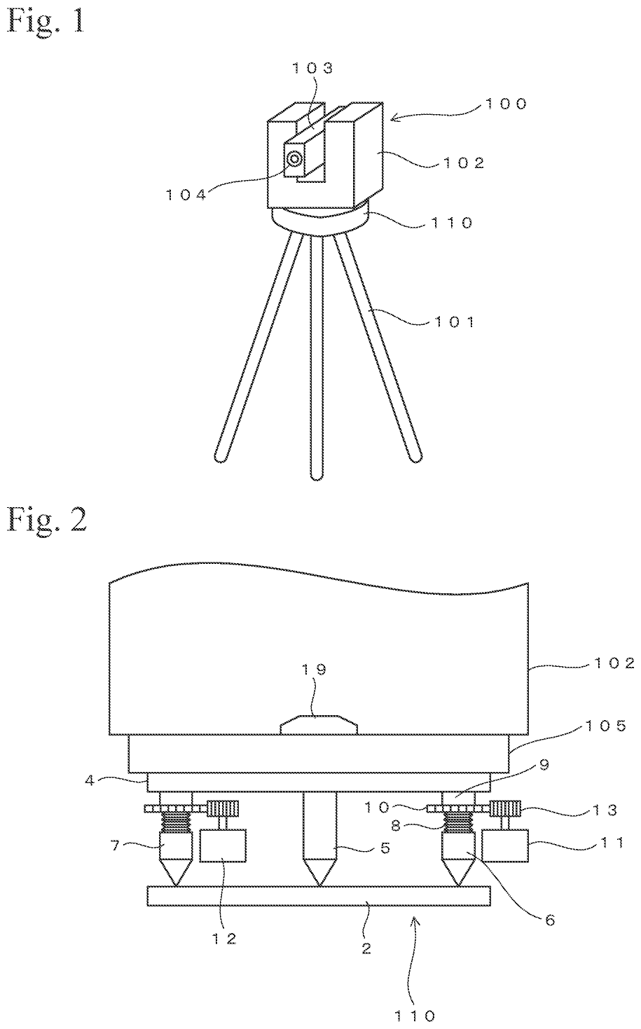

The automatic leveling mechanism 110 makes the horizontal rotation unit 102 level. Details of the automatic leveling mechanism are disclosed in, for example, Japanese Patent No. 6490477. FIG. 2 is a conceptual diagram of the automatic leveling mechanism 110. The automatic leveling mechanism 110 has a seat plate 2 and a leveling plate 4. The seat plate 2 is fixed on top of the tripod 101 in FIG. 1. The leveling plate 4 is supported from a downward side by the seat plate 2 and is adjustable in tilt relative to the seat plate 2.

The leveling plate 4 has three support pins 5, 6, and 7 at a lower part, and a lower end of each support pin is in contact with a top surface of the seat plate 2. The support pins 5, 6, and 7 are disposed at positions of apexes of a triangle as seen from an axial direction (upper-lower direction). The lower ends of the support pins 6 and 7 are movable (extendable and retractable) in the upper-lower direction relative to the leveling plate 4 by motor driving, and tilt of the leveling plate 4 relative to the seat plate 2 is adjusted by this movement.

In more detail, the support pin 6 has an external screw 8 at the axial center, and the external screw 8 meshes with a nut 9 that is rotatably fixed to the leveling plate 4. The nut 9 is integrated with a large gear 10 into one body, and the large gear 10 meshes with a small gear 13 that is driven by a motor 11. The support pin 6 is made not rotatable relative to the leveling plate 4, but is movable in the upper-lower direction by a guide mechanism (not shown).

In response to the motor 11 being rotated, the rotational force is transmitted to the large gear 10 via the small gear 13, and the nut 9 is rotated. As the nut 9 rotates, the external screw 8 is axially moved relative to the nut 9 by the action of the screw. This varies the length (protruded length) of the support pin 6 protruding downward from the leveling plate 4.

Similarly, the support pin 7 has an up-down movement mechanism the same as that of the support pin 6, and the length of the support pin 7 protruding downward from the leveling plate 4 can be adjusted by a motor 12 independently of the support pin 6. That is, the length of the support pin 6 protruding from the leveling plate 4 is adjusted by rotating the motor 11, whereas the length of the support pin 7 protruding from the leveling plate 4 is adjusted by rotating the motor 12. In this manner, tilt of the leveling plate 4 is adjusted.

A base 105 (not shown in FIG. 1) for rotatably holding the horizontal rotation unit 102 in FIG. 2 is fixed on a top surface of the leveling plate 4. The horizontal rotation unit 102 rotates relative to the base 105. Thus, adjusting tilt of the leveling plate 4 results in adjusting tilt of the horizontal rotation unit 102. A tilt sensor 19 is disposed in the inside of the horizontal rotation unit 102. The tilt sensor 19 measures tilt from a horizontal direction of the horizontal rotation unit 102. With this structure, tilt of the horizontal rotation unit 102 is adjusted by adjusting tilt of the leveling plate 4.

In one example, the last state at a time preceding leveling is set as the initial state. In this state, tilt from the horizontal direction of the horizontal rotation unit 102 (body of the total station 100) is obtained based on a measurement value of the tilt sensor 19. In the case in which the value of tilt is not greater than a specified value, the automatic leveling process is completed.

In the case in which the value of tilt is greater than the specified value, the length of one or each of the support pins 6 and 7 protruding from the leveling plate 4 is adjusted by motor driving, so that the obtained value of tilt will be not greater than the specified value. This adjustment is performed in the automatic leveling process.

The automatic leveling mechanism 110 can also be leveled manually. Manual leveling is performed by turning a fine adjustment dial (not shown) by hand, to adjust the protruded length of one or each of the support pins 6 and 7.

### Block Diagram

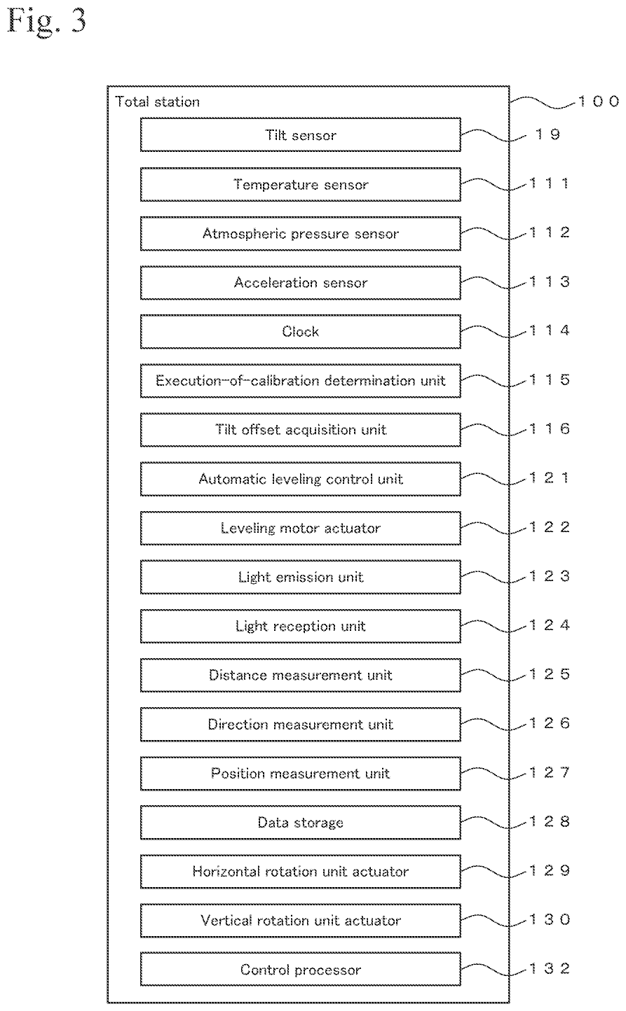

FIG. 3 is a block diagram of the total station 100. The total station 100 includes a tilt sensor 19, a temperature sensor 111, an atmospheric pressure sensor 112, an acceleration sensor 113, a clock 114, an execution-of-calibration determination unit 115, a tilt offset acquisition unit 116, an automatic leveling control unit 121, a leveling motor actuator 122, a light emission unit 123, a light reception unit 124, a distance measurement unit 125, a direction measurement unit 126, a position measurement unit 127, a data storage 128, a horizontal rotation unit actuator 129, a vertical rotation unit actuator 130, and a control processor 132.

Each of the functional units, which are the execution-of-calibration determination unit 115, the tilt offset acquisition unit 116, the automatic leveling control unit 121, the distance measurement unit 125, the direction measurement unit 126, the position measurement unit 127, the data storage 128, and the control processor 132, is implemented by a computer. One or more of the functional units may be composed of a dedicated electronic circuit.

The tilt sensor 19 is a sensor unit that measures tilt by using a bubble. It is also possible to use a tilt sensor that measures tilt based on another principle.

The temperature sensor 111 measures a temperature of the tilt sensor 19 or a temperature of an environment in which the tilt sensor 19 is placed. The temperature of the tilt sensor 19 is preferably measured. For example, when sunlight directly hits the total station 100, the temperature of the tilt sensor 19 that is disposed inside the housing case of the total station 100 may rise, even though the air temperature does not change. In such a situation, the temperature of the tilt sensor 19 inside the housing case is preferably measured instead of the outside temperature.

The atmospheric pressure sensor 112 measures an atmospheric pressure applied to the tilt sensor 19. The acceleration sensor 113 measures an acceleration applied to the tilt sensor 19. The measured value of each sensor is stored in the data storage 128 in association with a measurement time. The clock 114 counts time.

The execution-of-calibration determination unit 115 determines whether to perform a calibration process (a process related to acquisition of a tilt offset), based on one or more of the temperature sensor 111, the atmospheric pressure sensor 112, the acceleration sensor 113, elapse of time from the previous calibration (acquisition of the tilt offset), and detection or non-detection of abnormality.

The value of a tilt angle that is measured by the tilt sensor 19 includes an offset value called a “tilt offset.” The tilt offset can be affected by temperature, impact, vibration, etc., and it varies with the elapse of time.

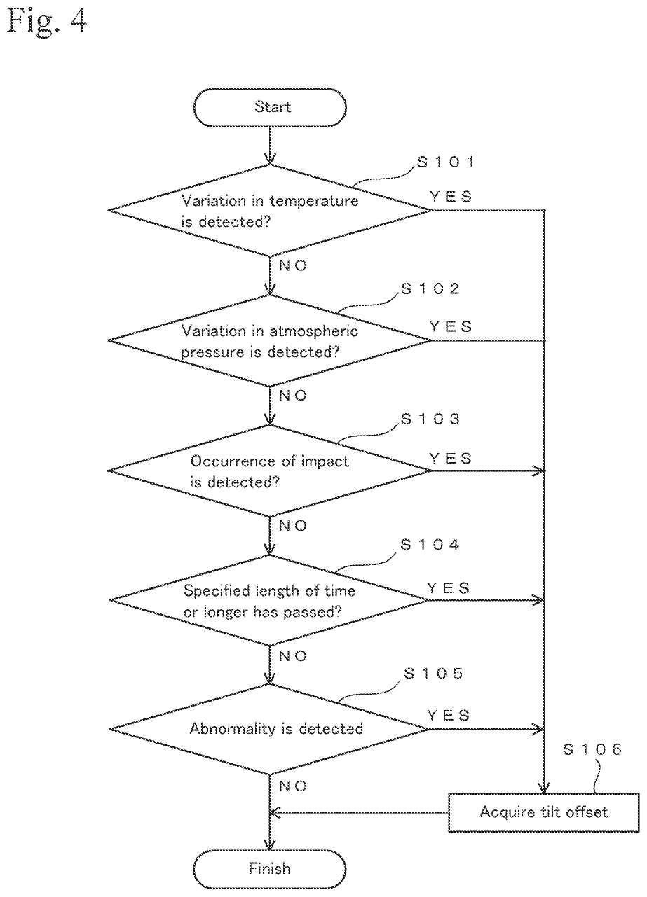

The execution-of-calibration determination unit 115 determines conditions that are likely to vary the tilt offset, and in a case in which the tilt offset is expected to vary, it determines to perform the calibration process of the tilt offset. On the other hand, in the case in which the tilt offset is not expected to vary, the execution-of-calibration determination unit 115 determines that acquisition of a new tilt offset is not necessary. This determination enables avoiding wasting time in acquiring the tilt offset. FIG. 4 shows an example of a determination procedure. Details of this processing will be described later.

The tilt offset acquisition unit 116 acquires a tilt offset of the tilt sensor 19. The following describes an example of a method of acquiring the tilt offset. First, the horizontal rotation unit 102 is oriented to a certain direction (hereinafter, a positive direction), and an X-tilt angle X1 and a Y-tilt angle Y1 of the tilt sensor 19 are obtained. Then, the horizontal rotation unit 102 is rotated (in the opposite direction) by 180 degrees from the positive direction to be oriented in a negative direction, and in this state, an X-tilt angle X2 and a Y-tilt angle Y2 of the tilt sensor 19 are obtained.

Next, an X-offset=(X1+X2)/2 and a Y-offset=(Y1+Y2)/2 are calculated. The X-offset and the Y-offset are used as the tilt offset. This tilt offset is used as a correction value to correct the measurement value of the tilt sensor 19, whereby a tilt angle from the horizontal direction of the horizontal rotation unit 102 is obtained.

The automatic leveling control unit 121 generates a control signal for controlling operation of the motors 11 and 12 in FIG. 2, so that the tilt angle from the horizontal direction of the horizontal rotation unit 102 (body of the total station 100), which is measured by the tilt sensor 19, will not be greater than a specified value. The leveling motor actuator 122 drives the motors 11 and 12 based on the control signal generated by the automatic leveling control unit 121.

The light emission unit 123 includes a light emitting element, peripheral circuits, and an optical system, and it emits distance measuring light (pulsed laser light) for measuring a distance. The light reception unit 124 includes a light receiving element, peripheral circuits, and an optical system, and it receives distance measuring light that is reflected back from a target and then outputs a light reception signal.

The distance measurement unit 125 calculates a distance to a reflection point that reflects distance measuring light. In this example, distance measuring light is output from the light emission unit 123 and is split into two beams. One beam is emitted from the optical unit 104 to the outside, whereas the other beam is led to a reference optical path set in the inside of the total station 100. The light reception unit 124 receives distance measuring light that has been reflected back from a target and also receives distance measuring light that has propagated through the reference optical path.

The reference optical path is short, and therefore, the other beam of distance measuring light that has propagated through the reference optical is detected first, and the one beam of distance measuring light that has been reflected back from a target is then detected. A distance from the optical origin of the total station 100 to a reflection point is calculated from a phase difference between detection signals of the two beams of distance measuring light. The distance can also be calculated by measuring a time-of-flight of distance measuring light.

The direction measurement unit 126 measures an emission direction of distance measuring light. Each of a horizontal rotation angle of the horizontal rotation unit 102 and a vertical rotation angle of the vertical rotation unit 103 is accurately measured by an encoder. The emission direction of distance measuring light is measured based on light emission timing. This direction is acquired as a direction of a reflection point (measurement point) of distance measuring light as seen from the total station 100.

The position measurement unit 127 calculates a three-dimensional position of the measurement point. Herein, assuming that the optical origin of the total station 100 is the origin, a three-dimensional position of the measurement point is calculated as data of a distance and a direction from the origin. In this state, in the condition in which exterior orientation parameters (position and attitude) in an absolute coordinate system of the total station 100 are known, coordinates in the absolute coordinate system of a measurement point are obtained.

The data storage 128 stores data and a program that are necessary to operate the total station 100, and data obtained during processing and as a result of operation.

The horizontal rotation unit actuator 129 drives a motor for horizontally rotating the horizontal rotation unit 102. The vertical rotation unit actuator 130 drives a motor for vertically rotating (controlling an elevation angle and a depression angle of) the vertical rotation unit 103.

The control processor 132 is a control computer that controls operation of the total station 100. One or more of the functional units shown in the block diagram in FIG. 3 may be implemented by this control computer.

### Example of Processing

The following describes an example of processing related to calibration of the tilt offset. FIG. 4 is a flowchart showing an example of a processing procedure. The program for executing the processing in FIG. 4 is recorded in the data storage 128 or an appropriate recording medium and is executed by a central processing unit (CPU) of the computer that constitutes the control processor 132.

As preparation, a user sets up the total station 100 at an instrument point at a surveying site. After the total station 100 is set up, the processing in FIG. 4 is started. At this point of time, the tilt offset is already acquired in a previous step of this processing.

First, occurrence of variation in temperature is determined (step S101). In this step, it is determined whether a variation range of temperature that is measured by the temperature sensor 111 after the tilt offset is acquired at the previous time, exceeds a predetermined range.

A threshold of the variation range of temperature, which is to be used in the determination, is set in advance by examining a relationship between the temperature variation and the tilt offset.

The following describes an example of the process in step S101. In one example, an acceptable variation range of temperature that is determined in advance is 5° C. It is also assumed that the measured temperature at the time the tilt offset is acquired at the previous time is 25° C. and that the measured temperature at the time of the determination in step S101 is 32° C. In this case, the variation range of temperature is 7° C., and therefore, the determination in step S101 results in YES.

In another example, the measured temperature at the time the tilt offset is acquired at the previous time may be 25° C., and the measured temperature then rises to 33° C. Thereafter, the measured temperature falls and reaches 26° C. at the time of the determination. In this case, the maximum value of the variation range of temperature is 8° C., whereby the determination in step S101 results in YES.

In yet another example, the measured temperature at the time the tilt offset is acquired at the previous time is 25° C., and the measured temperature then rises to 28° C. Thereafter, the measured temperature falls to 22° C. at the time of the determination. In this case, the maximum value of the variation range of temperature is 6° C., whereby the determination in step S101 results in YES.

In step S101, it may be determined that “temperature variation is detected.” In this case, the processing advances to step S106, the tilt offset is acquired in accordance with the explanation described in relation to the tilt offset acquisition unit 116.

In the case in which the determination in step S101 results in NO, the processing advances to step S102. Otherwise, the processing advances to step S106, and the tilt offset is acquired. In step S102, it is determined whether an atmospheric pressure varies by a degree exceeding a specified variation range after the tilt offset is acquired at the previous time. In the case in which such a change in atmospheric pressure is detected, the processing advances to step S106. Otherwise, the processing advances to step S103.

In step S103, it is determined whether an absolute value of acceleration that is measured by the acceleration sensor 113 after the tilt offset is acquired at the previous time, exceeds a predetermined upper limit. This upper limit is determined in advance by examining a relationship between the tilt offset and acceleration that is applied to the tilt sensor 19.

The process in step S103 determines the probability of variation in tilt offset due to impact. In the case of determining that impact causing excess of the predetermined upper limit has occurred, the processing advances to step S106. Otherwise, the processing advances to step S104.

In step S104, it is determined whether elapse of time from acquisition of the tilt offset at the previous time is a predetermined time or later. The predetermined time is selected in a range between 15 to 30 minutes.

In the case in which the elapse of time from acquisition of the tilt offset at the previous time is determined as being the predetermined time or later in step S104, the processing advances to step S106. Otherwise, the processing advances to step S105.

In step S105, it is determined whether an abnormal value is observed among measurement values of the tilt sensor 19, the temperature sensor 111, the atmospheric pressure sensor 112, and the acceleration sensor 113 after the tilt offset is acquired at the previous time. A measured value unlikely to be measured in normal operation, an abnormal variation or omission of a measured value, or failing to obtain output from each sensor may be observed. In this case, it is presumed that an abnormality is detected, and the determination in step S105 results in YES, whereby the processing advances to step S106.

In the case in which the determination in step S105 results in NO, or after the tilt offset is acquired in step S106, the processing is completed.

### Advantageous Effects

The tilt offset of the tilt sensor 19 varies due to variations in temperature or atmospheric pressure, effects of an impact, or the like. In addition, the tilt offset of the tilt sensor 19 gradually varies with the elapse of time. In the processing in FIG. 4, when the tilt offset of the tilt sensor 19 is expected to vary, the tilt offset is acquired again (step S106). Otherwise, the tilt offset is not acquired.

In one example, surveying is performed at a first instrument point by using the total station 100, and the total station 100 is then moved to a second instrument point to perform the next surveying thereat. In this situation, the tilt offset is acquired and automatic leveling is performed at the first instrument point.

After the total station 100 is set up at the second instrument point, the processing in FIG. 4 is performed. In the case in which the determination in each of steps S101 to S105 results in NO, acquisition of the tilt offset at the second instrument point is omitted. Therefore, the time required to acquire the tilt offset is unnecessary, resulting in improving efficiency of surveying operation. This advantageous effect is very useful, in particular, when there are numerous instrument points.

### 2. Second Embodiment

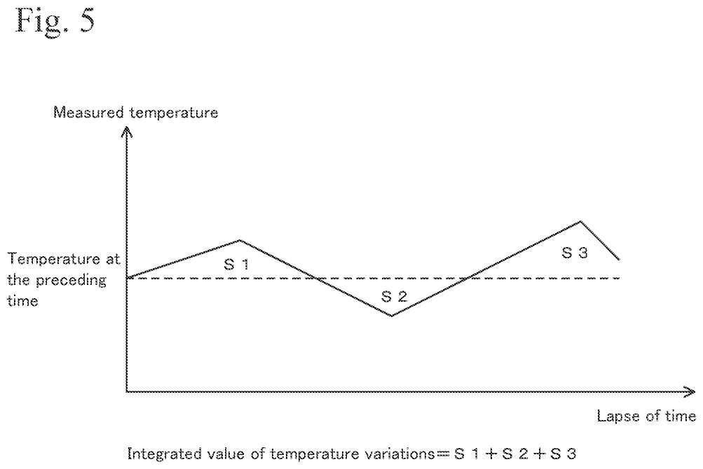

Temperature change can also be evaluated by a method of using an integrated value of temperature variations from a temperature at a starting point (at the time the tilt offset is acquired at the previous time). FIG. 5 shows an example of a case of calculating the integrated value. Specifically, a threshold is set for the integrated value, and the determination in step S101 is performed. This method can also be adopted for the determinations related to atmospheric pressure and impact.

### 3. Third Embodiment

When the surveying apparatus is placed on a soft ground or floor, tilt of the surveying apparatus can vary during the processing for acquiring the tilt offset. In order to cope with this, the following method is adopted. Specifically, a second tilt sensor is disposed at the base 105 or another part, which is a non-rotatable part that does not rotate while the horizontal rotation unit 102 rotates. This second tilt sensor is used to measure variations in tilt of the surveying apparatus itself during the processing related to the tilt offset. When the variations exceed a threshold, notification of error is given. Alternatively, when the variations exceed a threshold, correction is performed by using a mean value of the variation range or by another method, to reduce the error in the obtained value of tilt offset. This method of using the second tilt sensor described herein can also be used in other embodiments.

### 4. Fourth Embodiment

In one example, in surveying using a surveying apparatus having a camera (such as a total station or a laser scanning apparatus), the horizontal rotation unit of the surveying apparatus is horizontally rotated by 180 to 360 degrees, for the purpose of photographing surroundings by the camera or preliminarily measuring by using a measurement device. In this situation, in response to this movement, the tilt offset is acquired. This reduces the time related to acquisition of the tilt offset.

In one case, a camera is mounted on the horizontal rotation unit 102. Prior to surveying, the horizontal rotation unit 102 is rotated in order to perform photographing of the surroundings, and the camera performs photographing of the surroundings. At this time, while the horizontal rotation unit 102 is horizontally rotated by 180 degrees in order to perform photographing of the surroundings, the tilt offset is acquired.

In another case, a laser scanning apparatus having a horizontal rotation unit and a vertical rotation unit is used. A camera is mounted on this horizontal rotation unit. Prior to surveying, the horizontal rotation unit is rotated in order to perform photographing of the surroundings, and the camera performs photographing of the surroundings. At this time, while the horizontal rotation unit is horizontally rotated by 180 degrees, the tilt offset is acquired.

In another example, the horizontal rotation unit of the laser scanning apparatus is horizontally rotated by 180 degrees, and laser scanning data of the surrounding environment is obtained. At this time, the tilt offset is acquired. In yet another example, while an unmanned aerial vehicle (UAV) is tracked by a total station, a position of the UAV is measured. In this technique, the UAV is placed on a launch mounting or on a ground, and in this state, a target (a reflection prism or the like) mounted on the UAV is captured by the total station. Then, the UAV is launched to fly, and the UAV that is flying is tracked and the position thereof is determined by the total station.

In one case, during this operation, in response to the total station receiving an instruction for visually capturing the UAV before it flies, the tilt offset is acquired.

What is claimed is:

1. A surveying apparatus comprising:
a tilt sensor;
a tilt offset acquisition unit being configured to acquire a tilt offset of the tilt sensor;
a measurement unit being configured to measure a variable value of a phenomenon that can cause the tilt offset to vary; and
a determination unit being configured to determine whether to acquire the tilt offset, based on output from the measurement unit.

2. The surveying apparatus of claim 1, wherein the phenomenon includes at least one of variations in temperature, variations in atmospheric pressure, an impact, and an elapse of time.

3. The surveying apparatus of claim 1, wherein the measurement unit includes at least one of a temperature sensor, an atmospheric pressure sensor, an acceleration sensor, and a clock.

4. A surveying apparatus comprising:
a tilt sensor;
a tilt offset acquisition unit being configured to acquire a tilt offset of the tilt sensor; and
a determination unit being configured to determine whether to acquire the tilt offset, based on an elapse of time from acquisition of the tilt offset at a previous time.

5. A surveying apparatus comprising:
a horizontal rotation unit having a measurement device;
a tilt sensor being disposed on the horizontal rotation unit; and
a tilt offset acquisition unit being configured to acquire a tilt offset of the tilt sensor,
wherein the tilt offset is acquired when surrounding environment is measured by the measurement device while the horizontal rotation unit is rotated horizontally.

6. The surveying apparatus of claim 5, further comprising:
a non-rotatable unit supporting the horizontal rotation unit; and
another tilt sensor being disposed on the non-rotatable unit.

7. The surveying apparatus of claim 6, wherein variations in tilt of the surveying apparatus itself are measured by the another tilt sensor while the horizontal rotation unit is rotated horizontally.

8. A surveying apparatus being configured to perform surveying, the surveying apparatus comprising:
a tilt sensor; and
a tilt offset acquisition unit being configured to acquire a tilt offset of the tilt sensor,
wherein the tilt offset is acquired in response to reception of an instruction for executing specific surveying in the surveying.

9. The surveying apparatus of claim 8, further comprising:
a horizontal rotation unit mounted with the tilt sensor;
a non-rotatable unit supporting the horizontal rotation unit; and
another tilt sensor being disposed on the non-rotatable unit.

10. The surveying apparatus of claim 9, wherein variations in tilt of the surveying apparatus itself are measured by the another tilt sensor while the horizontal rotation unit is rotated horizontally.
